(19) United States
(12) Patent Application Publication
(10) Pub. No.: US 2003/0102399 A1
(43) Pub. Date: Jun. 5, 2003

(54) Winding or taping device and toroidal winding and taping system

(76) Inventor: Louis Steven Veress, Grafing b. (DE)

Correspondence Address: GARY CARY WARE & FREIDENRICH LLP, 1755 EMBARCADERO ROAD, PALO ALTO, CA, 94303-3340, US

(21) Appl. No.: 10/259,033

(22) Filed: Sep. 26, 2002

(30) Foreign Application Priority Data
Oct. 15, 2001 (DE) 101 50 818.2

(51) Int. Cl. H01F 41/08

(52) U.S. Cl. 242/434.7; 242/434.5

(57) ABSTRACT

The invention relates to a winding or taping device 100 to be disposed next to a toroidal winding device 700 which has an annular magazine designed for wire and/or tape guiding and magazining. The magazine is guided through a toroidal core opening and is rotatable about its rotationally symmetrical axis that is vertically aligned to the toroidal core axis and disposed on a magazine guide 120 movably with respect to a base 120 supporting the magazine 130.

The invention relates to a winding or taping device and a toroidal winding and taping system and in particular a taping system for arrangement next to a toroidal core coil winding device.

Toroidal winding devices and toroidal taping devices for the winding and taping of toroidal cores, which are in each case designed as so-called floor and bench machines, are known as toroidal core coil winding devices and toroidal core coil taping devices. Each winding and/or taping device has a toroidal core holding fixture for holding and guiding the toroidal core and an annular magazine that is designed for wire and/or tape guiding and magazining and for being guided through the toroidal core opening and, furthermore, a base which is preferably designed as a table on which the functional groups, toroidal core holding fixture and magazine, are disposed.

If a toroidal core is to be provided with a wire winding and a taping, the toroidal core is, first of all, inserted into a device, e.g. a toroidal core coil winding device, which is to provide the first winding, and provided with a wire winding. Subsequently, the toroidal core is removed from the toroidal core coil winding device and again clamped in a second device, e.g. a taping device, in order to provide it with a taping.

Here, it is especially disadvantageous that, for each wire winding and/or taping, a renewed inserting, adjusting and clamping and, after winding has been completed, a removal of the toroidal core is required. Moreover, only one winding and/or taping can always be wound onto the toroidal core during a winding process.

It is also disadvantageous in the taping devices known today that the toroidal cores are wound with a tape that has been previously magazined onto the hopper, the tape being on the magazine in several layers. If the tape is now wound from the magazine onto the toroidal core, it may happen that the tape either tears due to the too high friction between the tape layers, e.g. in the case of a crepe tape, or that the tape is wound to loosely onto the toroidal core due to a too low friction, e.g. in the case of a plastic tape.

Moreover, combined toroidal core coil winding and taping devices are known, in which two winding heads are disposed on a table so that two windings can be wound onto the toroidal core without having to remove the toroidal core temporarily from the combined toroidal core coil winding and taping device due to the fact that the first winding head has a wire magazine with which a wire winding is wound onto the toroidal core and the second winding head has a tape magazine with which a taping is subsequently placed wound onto the toroidal core.

However, it proved to be disadvantageous in such combined toroidal core coil winding and taping devices, in which different winding heads are disposed on a common base, that a combined winding and taping device that is adapted in each case must be designed and constructed for each toroidal core coil to be produced. In particular, it proved to be disadvantageous that all functional groups, including the toroidal core holding fixture, are disposed on one and the same base and, in particular for toroidal cores to be wound that have a large diameter, holding arms projecting to a great extent are required in order to position the functional groups around the toroidal core starting from a central base and/or a large table is required as a base in order to dispose the functional groups on the table so that they match the toroidal core.

Consequently, the invention is based on the object of improving known taping devices and providing a winding or taping device and/or a toroidal core coil winding and taping system, with which a winding or taping can be wound onto a toroidal core without removing the toroidal core from an already existing winding or taping device and which also allows the placing of the most different windings on toroidal cores of different sizes without complex special devices being required for this in each case.

This object is attained according to the invention by making available a winding or taping device to be disposed next to the toroidal core coil winding device which comprises an annular magazine designed for wire and/or tape guiding and magazining, which can be passed through the toroidal core opening, the magazine being rotatable about its rotationally symmetrical axis that is vertically aligned to the toroidal core axis, and the winding or taping device also comprises a base and a magazine guide on which the magazine is movable relative to the toroidal core and disposed on the base.

Such a winding or taping device is disposed next to a toroidal core coil winding device with toroidal core holding fixture, in which the toroidal core is held, and the magazine of the winding or taping device is aligned in such a fashion to the toroidal core via the magazine guide that a winding and/or taping of the toroidal core is made possible.

The toroidal core can now e.g. be taped or taped and wound at the same time without having to be removed from the toroidal core holding fixture of the existent winding device. Moreover, no modification of the already existent winding device is necessary since the taping device according to the invention has a base of its own and is simply disposed next to the already existent winding device.

The aforementioned object is also attained by a toroidal core coil winding and taping system which comprises several winding and/or taping devices, each winding and/or taping device comprising an annular magazine guided through the toroidal core opening and designed for wire and/or tape guiding and magazining and a base and a magazine guide on which the magazine is disposed movably relative to the toroidal core on the base. The system according to the invention also comprises a toroidal core holding fixture which is either designed as a separate device or disposed on one of the bases of the winding or taping devices of the system.

Thus, the toroidal core coil winding and taping system provides a modular system for winding the most different windings and tapes and/or the most different winding and taping sequences onto the most different toroidal cores. Thus, the system makes it possible to wind a desired winding and/or taping sequence onto a toroidal core with standardizable individual winding and taping devices without having to remove the toroidal core from the toroidal core holding fixture between the winding of individual windings and/or tapes. Thus, the invention provides a flexible system which renounces tailored special devices and rather makes it possible to supplement an existent system by disposing further taping and/or winding devices next to the system.

It is especially suitable to design the toroidal core coil winding and taping system as a modular system, in which different magazines and/or winding heads can be combined with different magazine guides and bases.

Moreover, the system makes it possible that several windings and/or tapes can be wound onto the toroidal core at the same time, since the individual winding and taping devices wind and/or tape the rotating toroidal core at the same time and in a staggered fashion.

Further advantages and details of the invention are explained in greater detail in the following with reference to the attached drawings by means of examples of embodiment.

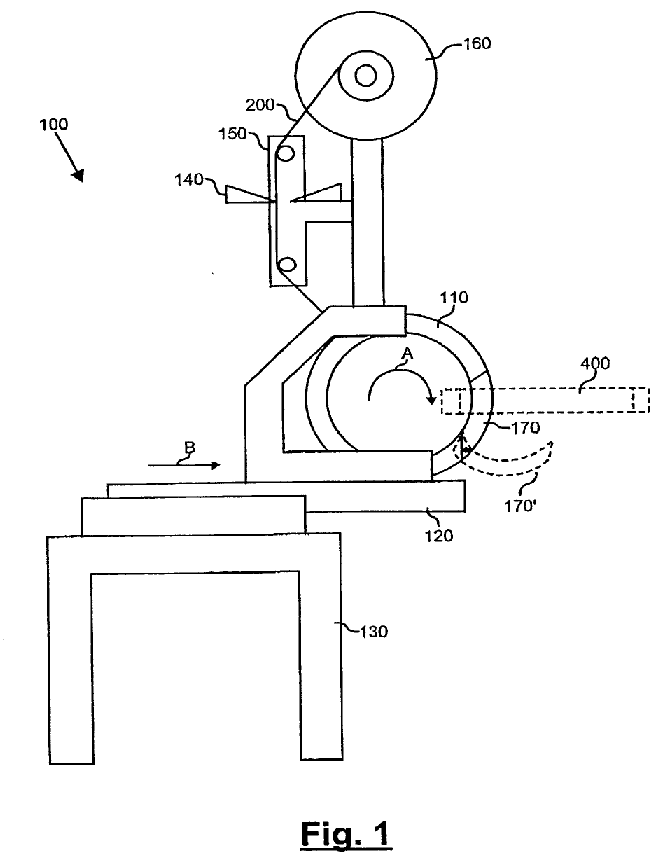

FIG. 1 shows a winding or taping device according to a first embodiment of the invention;

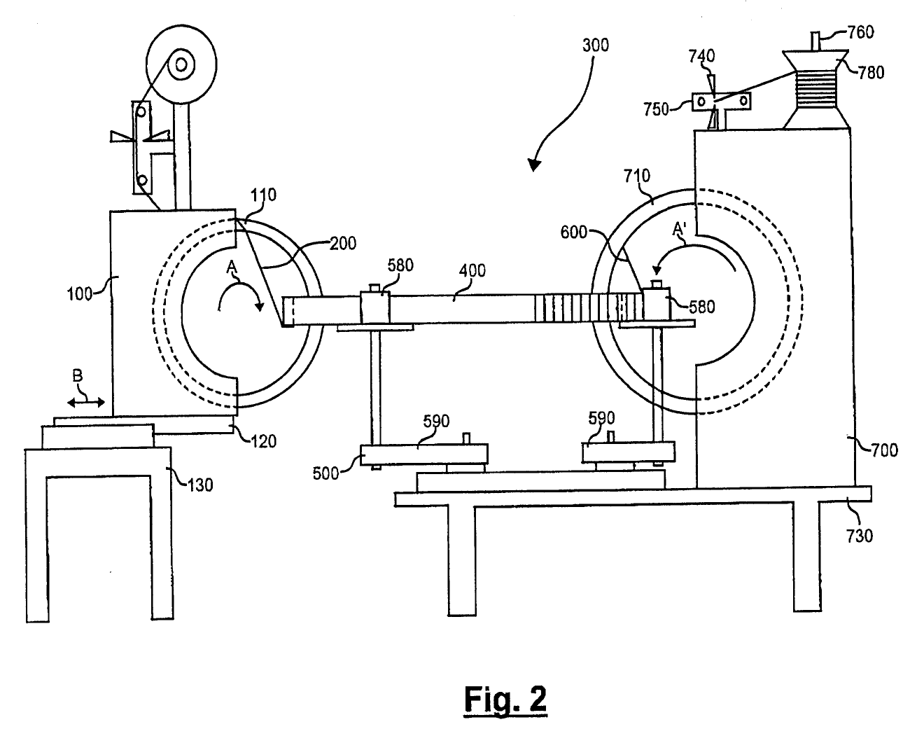

FIG. 2 shows a toroidal core coil winding and taping system according to a second embodiment of the invention;

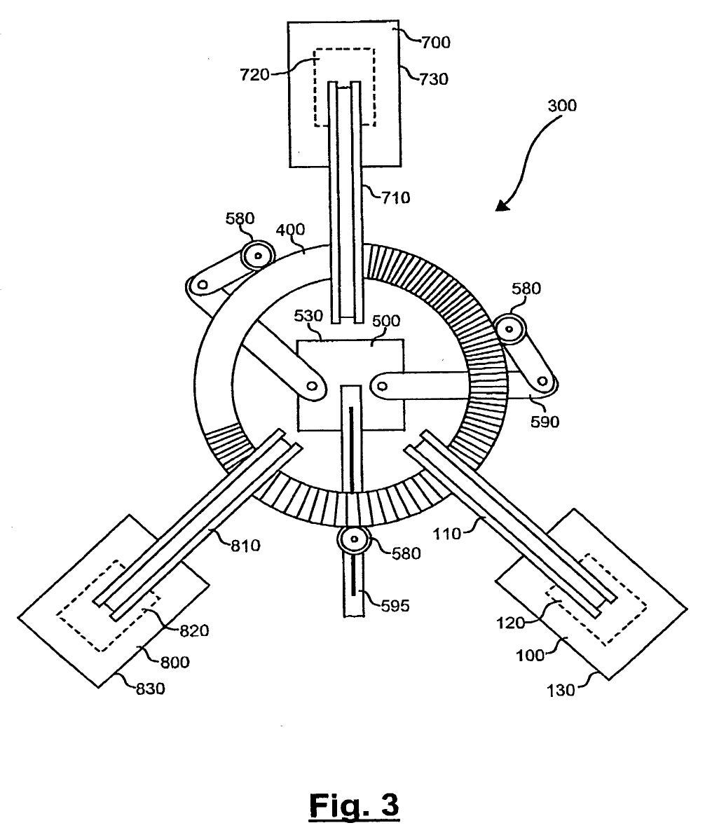

FIG. 3 shows a toroidal core coil winding and taping system according to a third embodiment of the invention; and

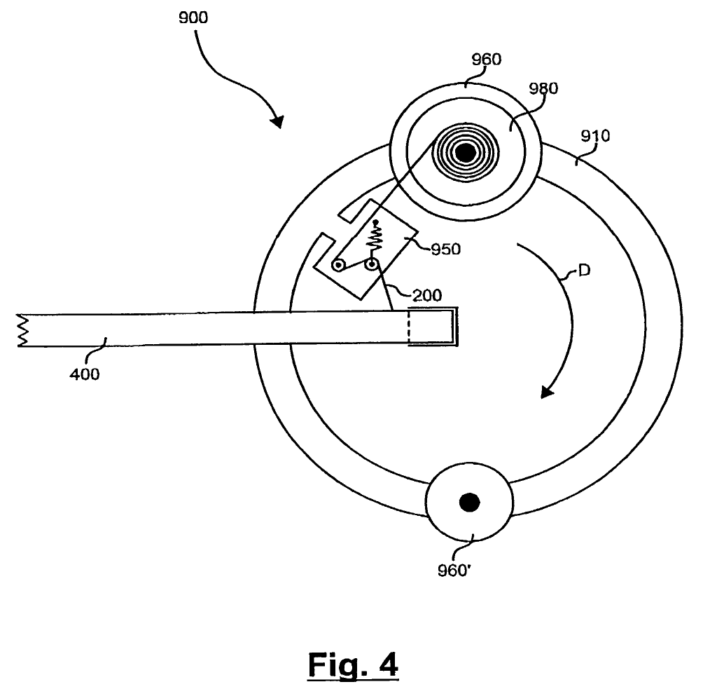

FIG. 4 shows a taping device according to a fourth embodiment.

FIG. 1 shows a winding or taping device 100 which is designed as a bench or floor machine. The winding device 100 has a base 130 designed as a table, on which a magazine guide 120 movably supports a winding head with a annular magazine 110. The winding device 100 also comprises a wire and/or tape supply coil receiving means 160 that is connected to the winding head and from which the wire or the tape 200 is supplied to the magazine 110 via a wire and/or tape tension regulating means 150. The winding head has suitably a wire and/or tape severing means 140 in the wire and/or tape path, by means of which optional lengths of the wire and/or tape can be cut off.

For the winding and/or taping of a toroidal core 400 that is represented in dashed lines in FIG. 1 the magazine 110 is first of all opened in a swivelling area (170) (the swivelling area is then located in a position that is represented in dashed lines in FIG. 1 and designated with the reference numeral 170′). Then, the winding head is guided along the direction of the arrow B in such a way across the toroidal core 400 by means of the magazine guide 120 that, after the closing of the swivelling area 170 the magazine 110 is guided through the toroidal core opening.

By means of a corresponding feeding of the wire and/or tape from the magazine to the toroidal core 400 and a rotation of the magazine 110 (arrow A), the toroidal core can be wound with the wire and/or tape magazined on the magazine 110. During this procedure the toroidal core 400 is held and guided by a toroidal core holding fixture (not shown).

FIG. 2 shows the cooperation of a taping device 100 with a winding device 700, which, preferably, applies windings and/or tapings onto the toroidal core 400 at the same time. The taping device 100 of FIG. 2 corresponds basically to that of FIG. 1. The winding device 700 has a table 730 as a base on which a winding head with a magazine 710 and a toroidal core holding fixture 500 are disposed. The winding device 700 also comprises a wire supply coil receiving means 760 for receiving a wire supply coil 780 from which the wire can be taken, a wire tension regulating means 750 and a wire severing means 740, which are suitably disposed on the winding head of the winding device 700 in such a way that a wire 600 can be fed to the magazine 710 in an optional length for magazining.

The taping device 100 together with the winding device 700 and the toroidal core holding fixture 500 results in a toroidal core coil winding and taping system 300 according to one embodiment of the invention. The system makes the simultaneous winding and taping of the toroidal core possible without having to remove it temporarily from the holding fixture.

A toroidal core coil winding and taping system 300 according to a further embodiment of the invention is shown in FIG. 3. In this embodiment, a toroidal core 400 is supported by a toroidal core holding fixture 500 which is disposed on a separate base 530. Taping or winding devices 100, 700, 800 are disposed in a circular fashion around the toroidal core 400, whose magazines 110, 710, 810 are guided through the toroidal core opening. For the simultaneous winding and taping of the toroidal core 400, the toroidal core is set rotating by the rollers 580 of the toroidal core holding fixture 500, which are holding it, and the wire and/or tape magazined onto the magazines are wound onto it in a predetermined layer sequence without having to temporarily remove the toroidal core 400 from the toroidal core holding fixture 500. Thus, it is e.g. possible to completely manufacture a toroidal core transformer with a toroidal core coil winding and taping system 400 by winding first of all a basic taping, followed by a primary winding, an intermediate taping, a secondary winding and finally a final taping onto the toroidal core. A separate taping and/or winding device could be provided for each winding and/or taping or the winding and taping could be carried out by respectively one taping and/or winding device.

Each taping and/or winding device 100, 700, 800 has its own base 130, 730, 830 in FIG. 3, on which the magazine guide 120, 720, 820 guiding the magazine 110, 710, 810 is disposed.

The magazine is suitably disposed on a gear rim which, in turn, is driven by a motor, e.g. a servo motor. This gear drive is especially advantageous for the winding with strong wires. In the case of smaller toroidal core diameters and the reduction in the magazine width required due to this, the magazine is preferably driven by a belt.

Moreover, the winding or taping device comprises suitably a control of its own with which the adjacently disposable device can be automatically controlled and, thus, can be operated completely independently of further winding devices in terms of control technology.

According to a further embodiment, the control of the winding or taping device is coupled with at least one control of an already existing taping and/or winding device 700, 800, whereby the taping and/or winding devices 100, 700, 800 coupled in this fashion can be controlled in a coordinatable fashion. Due to the coupled control, a synchronous operation of all taping and/or winding devices that are coupled as regards control technology can e.g. be ensured. Moreover, is possible due to the coupling of the controls of the individual winding and/or taping devices in the toroidal core coil winding and taping system to provide a central control for all winding and/or taping devices which then drives the individual taping and/or winding machines e.g. via a system of field busses.

The magazine guide 120, 720, 820 which is suitably secured onto the base is suitably a carriage that displaceably supports the winding head with the magazine along a straight line (arrow B). In a preferred embodiment the carriage is an X-Y carriage with which the magazine can be displaced both in the X and Y directions. In a further embodiment the magazine guide is designed as a swinging arm by means of which the magazine can be optionally positioned with respect to the toroidal core.

The rollers 580 of the toroidal holding fixture 500 are, as shown in FIG. 3, also movably disposed on the toroidal holding table 530. A rail and/or a carriage 595 and swinging arms 590 are used, which support the rollers 580. Thus, toroidal cores of optional size can be held and guided without there being a collision or hindrance between toroidal core holding fixture and taping and/or winding device. In particular due to the adjacently disposable taping device according to the present invention, taping tasks can be implemented by means of a machine for which, so far, the toroidal core had to be removed from the toroidal core holding fixture of an already existent winding device or, so far, the taping has been carried out manually. Thus an especially flexible application possibility results for the aforementioned devices and systems.

The flexible system with separate winding or taping devices on their respectively own bases also permits to supplement already existent systems for additional winding tasks by disposing an additional taping or winding device next to them without the existent system having to be modified.

FIG. 4 shows in part a taping device according to a further embodiment of the invention, which is in particular suited for the taping of large toroidal cores.

The taping device 900 distinguishes itself by the fact that a tape roller 960 is disposed on the magazine 910 which rotates about the toroidal core 400 with the magazine rotating. The tape roller is rotatably supported by an axis aligned in parallel to the axis of the magazine. If a tape to be wound onto the toroidal core is magazined on the tape roller and a tape end is guided to the toroidal core, the tape roller rotates about the toroidal core with the magazine rotating, whereby the toroidal core is taped with the tape 200.

In a further preferred embodiment a further tape roller 960′ is disposed on the magazine 910 in a locally staggered fashion with respect to the first tape roller 960 which, basically, functions in the same way as the first tape roller and by means of which a further tape can be wound onto the toroidal core for taping at the same time as the first tape or in a deferred fashion.

Due to the use of several tape rollers, different types of tapes can e.g. be kept as a supply on one magazine which can then be wound onto the toroidal core in each case without the necessity of a changing of the toroidal core. Moreover, it is possible due to the use of several tape rollers to wind several layers of a tape or different tapes onto the toroidal core at the same time with one magazine.

In a further embodiment of the invention a tape tension regulating means 950 is also disposed on the magazine, which regulates the tape tension of the tape magazined on a tape roller 960. The tape tension regulating means automatically produces the desired tape pull-off tension according to the necessary tape pull-off compensation per tape roller rotation with respect to different toroidal core cross-sections. The tape tension regulating means makes it possible that all commonly used tape materials or types of tape such as plastic tapes, crepe tapes, paper tapes, cotton tapes, glass silk tapes, copper mesh tapes, hostaphan tapes, aluminized tapes, etc. can be used. This is made possible by the fact that the tape, on the one hand, is not magazined onto the magazine circumference and thus no friction problems between superimposed tape layers occur, but that the tape is directly wound onto the toroidal core from a tape supply coil 980 which is slipped onto the tape roller that is suitably designed as an axis and, on the other hand, due to the observing of the correct tape pull-of tension by the tape tension regulating means.

The tape tension regulating means suitably comprises two deflection pulleys around which the tape is guided, at least one deflection pulley being resiliently mounted in such a way that variations in the tension are compensated by the spring system.

An embodiment of the tape tension regulating means as a compensating carriage is especially preferred, which is resiliently mounted on the magazine by means of a tension spring. If a tape 200 to be wound is guided across the compensating carriage and the magazine 910 with the tape roller 960 and the tape supply coil 980 that is slipped onto it is rotated about the toroidal core 400 (in the direction of the arrow D), the compensating carriage regulates the tape tension upon each rotation due to the fact that the tension spring moves the compensating carriage relative to the tape roller 960 in the case of a stronger or weaker tape tension. Thus, the compensating carriage automatically compensates the tape tension per rotation via the tension spring.

Due to the suggested taping device larger amounts of tape can also be wound around the toroidal core in the case of large-size toroidal core coils by directly slipping the tape supply coils with the tape on a tape roller on the magazine without a remagazining of the tape on the toroidal core circumference having to take place prior to the actual winding. Due to this type of taping, a tearing of the tape during taping can, in particular, be avoided.

The taping device described with reference to FIG. 4 can also be designed as a wire winding device where a wire from a supply coil is wound onto the toroidal core instead of the tape.

Further advantageous developments and modifications result in obvious fashion from the embodiments described here by a person skilled in the art and are understood by him as forming part of the invention.

1. A winding or taping device to be disposed next to a toroidal core winding device comprising an annular magazine that guided through a toroidal core opening and is designed for wire and/or tape guiding and magazining, the magazine being rotatable about its rotationally symmetrical axis that is aligned vertically to the toroidal core axis, a base and a magazine guide on which the magazine is disposed movably relative to the toroidal core on the base.

2. A winding or taping device according to claim 1, further comprising a wire and/or tape severing means, a wire and/or tape tension regulating means and a wire and/or tape supply coil receiving means.

3. A winding or taping device according to claim 1, wherein the magazine being disposed on a gear rim and the gear rim being drivable by a motor.

4. A winding or taping device according to claim 1, wherein the magazine being driven by a belt.

5. A winding or taping device according to claim 1, wherein the magazine having a swivelling area and, in a fitting phase, in which the magazine is not guided through the toroidal core, the magazine guide guides the magazine in a swivelled condition across the toroidal core and the swivelling area is subsequently folded.

6. A winding or taping device according to claim 1, wherein the magazine guide being designed as a carriage.

7. A winding or taping device according to claim 1, wherein the magazine guide being designed as a swinging arm.

8. A winding or taping device according to claim 1, furthermore comprising a control with which the device can be operated independently or synchronously with the toroidal core coil winding device.

9. A taping device according to claim 1, further comprising at least a first tape roller disposed on the magazine for receiving a tape, the tape roller being rotatable about its axis that is aligned in parallel to the axis of the magazine and the tape roller rotating about the toroidal core by means of the rotation of the magazine.

10. A taping device according to claim 9, further comprising at least one further tape roller which is disposed rotatably on the magazine in a locally staggered fashion with respect to and in parallel to the first tape roller.

11. A taping device according to claim 9, further comprising a tape tension regulating means being disposed on the magazine and belonging to the tape roller.

12. A taping device according to claim 11, wherein the tape tension regulating means comprising a compensating carriage with a tension spring.

13. A toroidal winding and taping system comprising several winding and/or taping devices, each winding and/or taping device comprising an annular magazine that is designed for wire and/or tape guiding and magazining and guided through a toroidal core opening, each magazine being rotatable about its rotationally symmetrical axis that is vertically aligned to the toroidal core axis and a base and a magazine guide on which the magazine is disposed on the base movably relative to the toroidal core and the system further comprises a toroidal core holding fixture.

14. A toroidal winding and taping system according to claim 13, wherein the toroidal core holding fixture having a base of its own and being independent of the winding and/or taping devices.

15. A toroidal winding and taping system according to claim 13, the toroidal core holding fixture being a component of one of the taping and/or winding devices.

16. A toroidal winding and taping system according to claim 13, wherein each winding and taping device having a base of its own.

17. A toroidal winding and taping system according to claim 13, wherein the bases being in each case designed as a table.

18. A toroidal winding and taping system according to claim 13, further comprising a winding or taping device according to claim 1.

19. A toroidal winding and taping system according to claim 13, wherein the winding and taping devices being disposed circularly around the toroidal core in a mutually spaced relationship.
